(19) United States
(12) Patent Application Publication
(10) Pub. No.: US 2002/0107776 A1
(43) Pub. Date: Aug. 8, 2002

(54) System and method for anonymous lead generation and management

(75) Inventors: Stephen B. Bove, Westlake Village, CA (US); Marty C. Frame, California, CA (US); Michael A. Kalousek, Canyon Country, CA (US); Nancy B. Lehrer, Thousand Oaks, CA (US); Natasha N. MacPherson, Oak Park, CA (US); Maria Veronica Pennington, Northridge, CA (US); Anil K. Palat, Virginia Beach, VA (US); Stuart Wolff, Westlake Village, CA (US)

Correspondence Address: John D Titus, Esq., GALLAGHER & KENNEDY, P.A., 2575 East Camelback Road, Phoenix, AR, 85016-9225, US

(73) Assignee: Homestore.com

(21) Appl. No.: 09/777,492

(22) Filed: Feb. 5, 2001

(51) Int. Cl. G06F 17/60

(52) U.S. Cl. 705/37

(57) ABSTRACT

A system and method for generating and managing anonymous leads from anonymously submitted database search criteria is disclosed. Device identifiers and status indicators are used to create records for consumers, wherein the records contain the database searching activity of those consumers. This search activity translates the consumer record into a prospect, which enables delivery of completely anonymous business leads to business experts. The system and method further allows submission of business expert proposals to the anonymous consumers, anonymous review of those proposals by the consumers, and anonymous communications between the consumers and the business experts.

### FIELD OF THE INVENTION

This invention relates to providing services via a computer network, specifically software application services directed to generating and managing anonymous leads to assist in the buying and selling of goods and/or services.

### DESCRIPTION OF RELATED ART

The Internet and the World Wide Web (“web”) enable companies to provide information services that are easy to access and simple to use. Common examples of such services are information search services, which include those directed to the web itself, such as those available at www.google.com or www.hotbot.com, and which also include those directed to business-specific, sometimes proprietary, databases.

In the field of web-directed search services, the practice of capturing submitted search criteria is common. For example, at www.google.com, an AdWords program is used to create highly targeted advertising. Advertisers can purchase particular keywords, such that when a user submits those keywords in a search request, the results displayed include an advertisement for the advertiser. This type of targeted advertising, based upon submitted search criteria, is common on the web today.

In the field of business-specific search services, the practice of using cookies to measure user traffic patterns to improve a web site's layout is common, as well as the practice of using cookies in combination with registration information to assess client demographics, interests and behavior. Some web sites, directed to the real estate business, provide home search services, which allow individuals to search for a home to purchase or rent. These search services provide quick access to millions of home listings, which can dramatically improve the home purchasing/renting experience.

However, this improvement is not guaranteed. For any search service, the larger the database is, the more difficult it can be to find the particular item in the database that is truly sought. Users of such search services often utilize wide ranging search criteria, thereby resulting in many hits, most of which are not desirable. Frequently, a user will perform multiple searches, slightly modifying the search criteria at each stage. These multiple searches will likely find most of the items in the database that are close to the desired item, but may also camouflage the desired item when it is found.

This is especially true when searching for a home. There are many features and amenities that affect the value and desirability of a home. Thus, there are many relevant search criteria when searching a database of home listings. The interrelationships of all these different features and amenities, and the uncertainty of those interrelationships, can cause a user to define search criteria too broadly, thereby causing too many hits to be found. This results in a sea of information that makes it difficult for a home buyer or renter to find the appropriate home.

Alternatively, this uncertainty can cause a user to define search criteria too narrowly, thereby resulting in the perfect home not even being presented in the search results. For example, a user may enter a minimum home price and a minimum square footage as search criteria that are inconsistent with each other, given the nature of the housing market. These problems are especially problematic for first time home buyers.

Because these problems are so acute in the real estate business, some web sites have attempted a solution. For example, HomeGain (www.homegain.com) provides a real estate agent finding service. HomeGain's Agent Evaluator allows a client to anonymously compare and contrast qualifications and proposals of representation from a number of real estate agents before choosing whom they want to meet and hire. However, HomeGain suffers from a number of problems, including a registration requirement and a need to submit private information.

A consumer of real estate who wishes to use HomeGain's Agent Evaluator must register with the site in order to obtain the benefits. Many web users would prefer to obtain the information they want fast, without the need to register with a web site. Additionally, the consumer must take the time to enter her personal profile information. This takes away additional time from the consumer, and is thus undesirable. Moreover, it raises a number of privacy issues, and thus tends to reduce the number of consumers who are willing to use the service.

Accordingly, the shortcomings associated with the related art have heretofore not been adequately addressed. The present invention addresses such problems by providing a system and processing approach that have not previously been proposed.

### SUMMARY OF THE INVENTION

This invention can be regarded as a system for anonymously connecting business experts with consumers by generating anonymous leads based upon search activity, which may be performed by anonymous consumers. The system includes a database for storing search information corresponding to submitted search criteria and a server engine coupled with a network. The search information is organized into prospects. The server engine is configured to provide the prospects to business experts in the form of anonymous leads, such that the business experts cannot identify or contact the consumer, who is the source of the prospect, independently from the system. The server engine is further configured to furnish proposals, generated by the business experts, to consumers.

This invention can also be regarded as a method for generating anonymous leads from anonymously submitted database search criteria. The method includes the steps of generating a prospect, providing prospect information to a business expert, and providing a resulting proposal to the device associated with the prospect. The prospect includes search information corresponding to search criteria, which may be anonymously submitted. In addition, in one embodiment, the search information also corresponds to post-search browsing activity data, such as a request for more information concerning a particular item from a set of search results.

This invention can also be regarded as a computer readable medium having computer program instructions stored therein, such that execution of the computer program instructions results in obtaining the benefits of this invention. The computer program instructions include instructions for generating a prospect having search information corresponding to anonymously submitted search criteria, instructions for providing prospect information to business experts, and instructions for providing proposals to devices associated with prospects for which the proposals are generated.

One object of this invention is to enable generation of business leads, which are completely anonymous. These business leads are anonymous in at least two respects: (1) they are anonymous in that a business expert reviewing the lead can neither identify nor contact the consumer independently from the lead generation system; and (2) they are anonymous in that even the provider of the lead generation system is generally unable to identify the consumer because the system is able to function using only a small set of device identifiers, which include both permanent and session identifiers.

Another object of this invention is to improve consumers' ability to obtain information concerning products and services by capturing search activity and presenting this as an anonymous prospect stream to business experts. When consumers perform searches, the search criteria are converted into prospects and prospect information is directed to appropriate business experts. By enabling business experts to contact consumers with proposals that are specific to the particular consumer's needs (including needs of which the consumer himself may not be aware), this invention creates opportunities for improved market efficiencies.

Further features and advantages of the invention as well as the structure and operation of various embodiments of the invention are described in detail below with reference to the accompanying drawings.

### BRIEF DESCRIPTION OF THE FIGURES

FIG. 1 is a block diagram illustrating an operational environment and various components of a server and a client device according to one embodiment;

FIGS. 2A and 2B are a combined state diagram and flowchart depicting a process by which activity of a consumer is used to generate prospects enabling creation and delivery of consumer-specific, anonymously-directed proposals according to one embodiment;

FIGS. 2C and 2D are two flowcharts depicting a process by which a consumer is provided access to consumer-specific, anonymously-directed proposals according to one embodiment;

FIGS. 3A, 3B, 3C and 3D are illustrations showing exemplary web pages for implementing various steps in the process by which a consumer is provided access to consumer-specific, anonymously-directed proposals according to one embodiment;

FIG. 4 is a flowchart depicting a process by which creation and delivery of consumer-specific, anonymously-directed proposals is enabled according to one embodiment; and

FIGS. 5A, 5B, 5C, 5D, 5E and 5F are illustrations showing exemplary web pages for implementing various steps in the process by which creation and delivery of consumer-specific, anonymously-directed proposals is enabled according to one embodiment.

### DETAILED DESCRIPTION OF THE INVENTION

The present invention is directed toward a system and method for generating and managing anonymous leads to assist in the buying and selling of goods and/or services The present invention is disclosed and described herein in terms of a web site running on a dedicated server utilizing the Internet and the World Wide Web. However, after reading this description, it will become apparent to one of ordinary skill in the art how to implement the invention in alternative embodiments and alternative network environments.

For example, alternative embodiments include alternative elements such as multiple servers for a web site, or user interfaces that utilize hyperlinking protocols other than the Hypertext Transfer Protocol (“HTTP”). Additionally, alternative embodiments include alternative types of databases, such as vacation planning databases, employee recruiting databases, or housing databases that includes information regarding real estate for sale, factory-built homes, common interest developments, and apartments for rent.

Alternative network environments include any large-scale wide area network and its accompanying networking protocols, which may encompass one or more functions now provided by today's Internet, cable and broadcast television, telephone communications and other linear and interactive business and telecommunications systems. As such, the description of this example embodiment should not be construed to limit the scope and breadth of the present invention.

The disclosure herein should be understood in light of the following definitions. The term “prospect” means a record, either localized or distributed, containing data, which includes information regarding a consumer's needs/preferences. The term “business” means a field of endeavor and/or commercial exchange, regardless of whether the specific area of endeavor and/or commercial exchange relates to the sale of goods or services. The term “business expert” means any person, whether natural or artificial, with specialized knowledge and/or skills related to a particular business, regardless of whether that person is a middleman, such as a real estate agent, or a provider of goods and/or services. The term “consumer” means a person, either natural or artificial, that acquires goods and/or services for direct use and/or ownership.

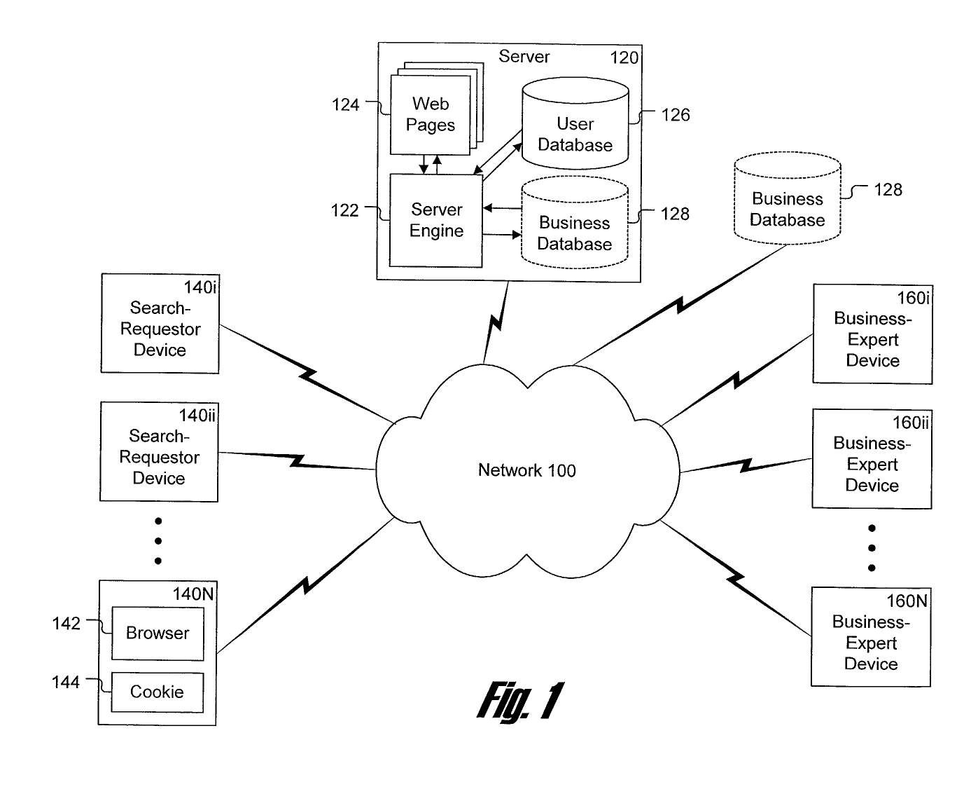

FIG. 1 is a block diagram illustrating an operational environment and various components of a server and a client device according to one embodiment. A network 100 provides a connection medium for a plurality of search-requestor access devices 140, a plurality of business-expert access devices 160 and a server 120. The network 100 is a computer network, such as the Internet, which allows multiple devices to be communicatively coupled together. In this example embodiment, the network 100 utilizes the Internet Protocol (“IP”) to enable this communicative coupling, and the network 100 includes both wire/fiber and wireless network components.

The plurality of search-requestor access devices 140 are any network-enabled devices capable of presenting a user interface having control inputs that effectuate network communications when selected. Examples of such control inputs include hyperlinks and submit buttons on Hypertext Markup Language/Extensible Markup Language (“HTML/XML”) forms. Examples of such network-enabled devices include devices such as a personal computer, a web browsing appliance, a personal digital assistant (“PDA”), a mobile phone, a game machine, a watch, and a home entertainment system.

The plurality of business-expert access devices 160 are any network-enabled devices capable of presenting a user interface having control inputs that cause network communications. Examples of such control inputs include hyperlinks and submit buttons on HTML/XML forms. Examples of such network-enabled devices include devices such as a personal computer, a web browsing appliance, a PDA, a mobile phone, a game machine, a watch, and a home entertainment system.

Although the invention is generally disclosed herein in terms of business-expert access devices 160 designed to present hyperlinked data in a graphical user interface, other types of interfaces are contemplated. For example, in one embodiment, a business-expert access device 160ii is a land based or wireless telephone, which is connectable to the network 100, and the user interface is a voice interface.

In one embodiment, the server 120 is a web server comprising a server engine 122, web pages 124, a user database 126, and a business database 128. The web server 120 can be built using any number of computer hardware platforms running standard web server software, such as Apache, Microsoft Internet Information Server, and Netscape Enterprise Server. Moreover, the web server software can be designed to function with any number of operating systems and may utilize any number of programming languages for implementing scripts, such as CGI scripts.

The server 120 provides an anonymous lead generation system in connection with database searching services. Consumers use the search-requestor access devices 140 to submit search criteria to the server 120. The search criteria relate to data stored in the business database 128, which may be part of the server 120 or separate from the server 120 and accessible via the network 100, or via a propriety network (not shown). In this exemplary embodiment, the business database 128 contains information relating to homes for sale. The anonymous lead generation system is implemented with software, which is part of the server engine 122, and the web pages 124.

In one embodiment, the web pages 124 are XML/HTML documents. The web pages 124 and the software enable dynamic creation of additional web pages 124. For example, when a consumer performs a search of the business database 128, the search results may be presented in web pages 124 that were either not in existence, or not in that exact form, before the search. The web pages 124 may be stored in a dedicated database or as part of a larger database.

The user database 126 stores user records containing information relating to registered consumers, unregistered consumers who have accessed the server 120, and business experts (e.g. real estate agents, or real estate offices). The term “user” is used herein to refer both to consumers (i.e. search-requestors) and business experts. At a minimum, this information includes a user identifier. In addition, this information includes the data used to implement the functionality described herein. This information may be stored in the user record, a customer record associated with the user record, or a combination of these. Moreover, after a search has been conducted, the information for both registered and unregistered consumers further includes search criteria data and, in some embodiments, post-search browsing data.

For example, in one embodiment, the search criteria data includes search dates, areas of interest, type of property, and price range, while post-search browsing data includes search-results' detailed description pages viewed and Multiple Listing Service (“MLS”) numbers saved. The information for registered consumers further includes additional information, such as name, contact information (e.g. e-mail address), user name and password. The information for business experts includes name, contact information, company/gateway association/affiliation, if any, and business areas of specialty.

For consumers, the user identifier is used in connection with the search-requestor access devices 140 to identify associations between particular consumers and particular devices. For an unregistered consumer, the user identifier is equivalent to a device identifier and is used as such. For a registered consumer, the user identifier uniquely identifies the registered consumer, and can thus be used as a device identifier on multiple search-requestor access devices 140.

For example, in an embodiment in which a search-requestor access device 140N is a personal computer with a web browser 142, when a consumer first accesses the server 120 with the personal computer, the server 120 generates a new user record having a user identifier. The server 120 then employs the user identifier as a device identifier by setting a permanent cookie 144 using the user identifier. In each subsequent request sent from the personal computer to the server 120, this permanent cookie 144 is included in the request, thereby enabling the server 120 to identify the source of the request, and thus the corresponding user record.

Likewise, when a registered consumer logs into the server 120 with the personal computer 140N, the server 120 retrieves the appropriate user record and thus the user identifier for that registered consumer. The server 120 then employs the user identifier as a device identifier by setting (or resetting) a permanent cookie 144 using the user identifier. In each subsequent request sent from the personal computer 140N to the server 120, this permanent cookie 144 is included in the request, thereby enabling the server 120 to identify the source of the request, and thus the corresponding user record for the registered consumer.

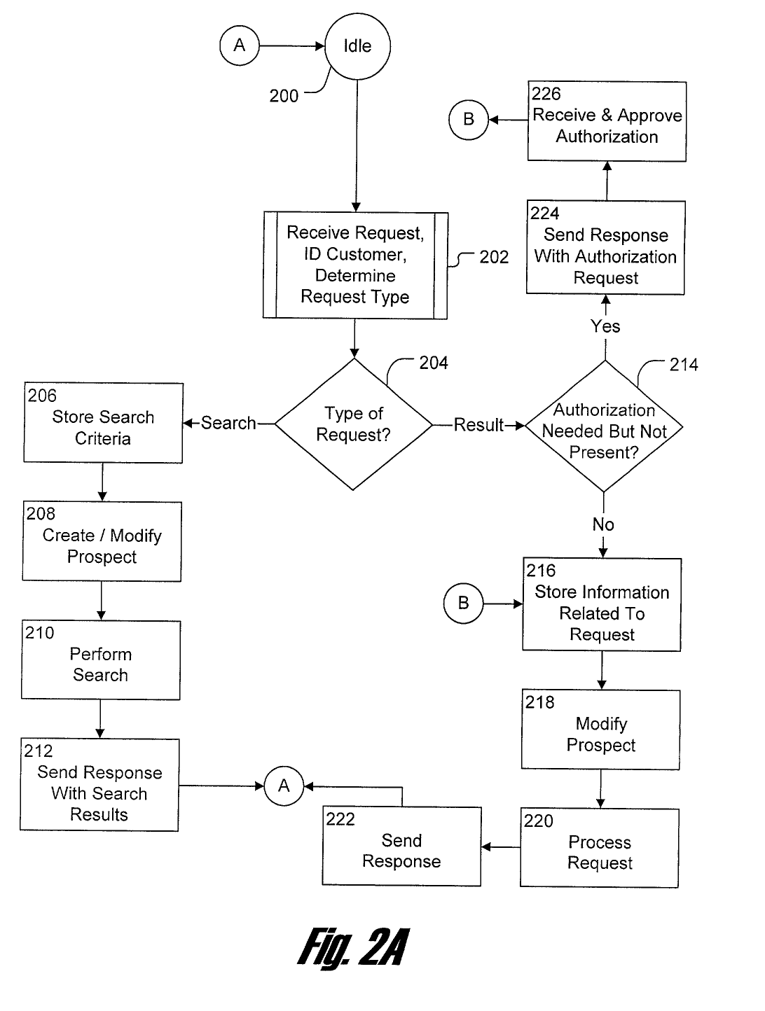

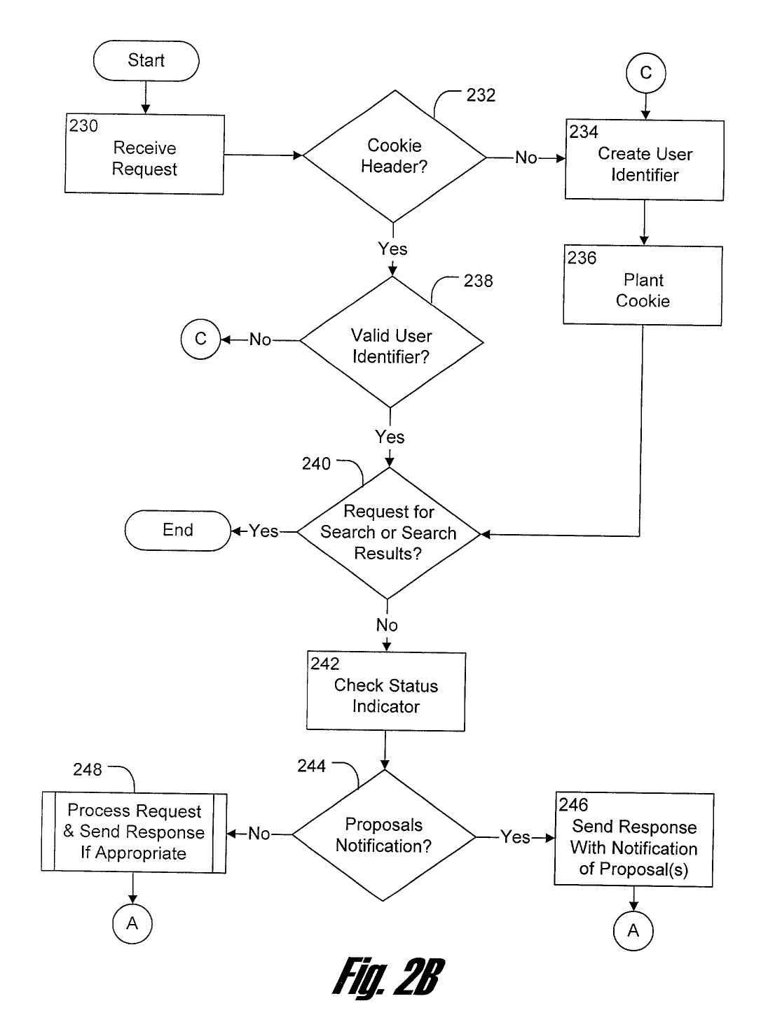

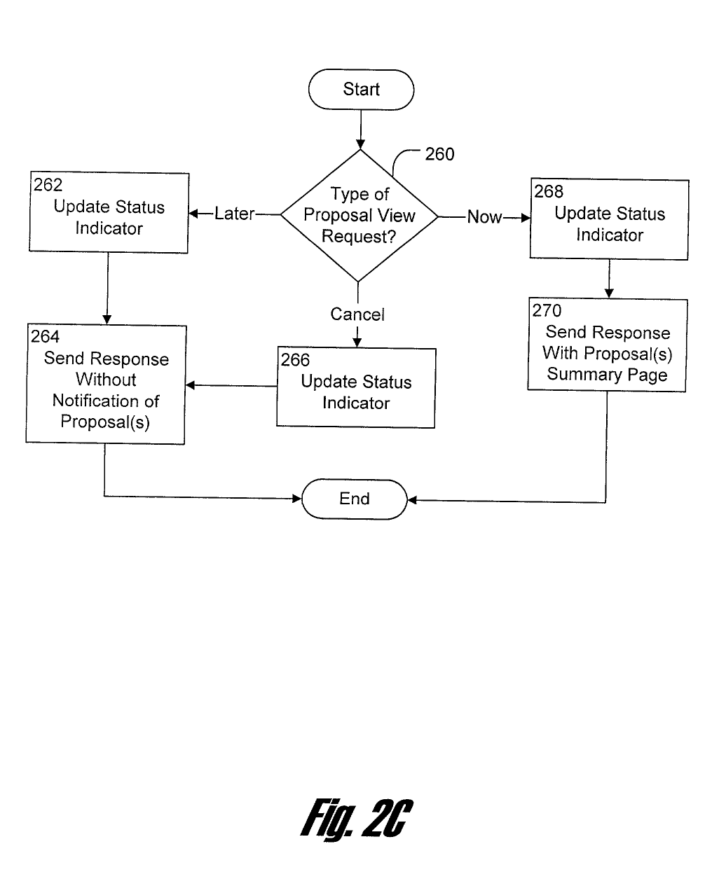

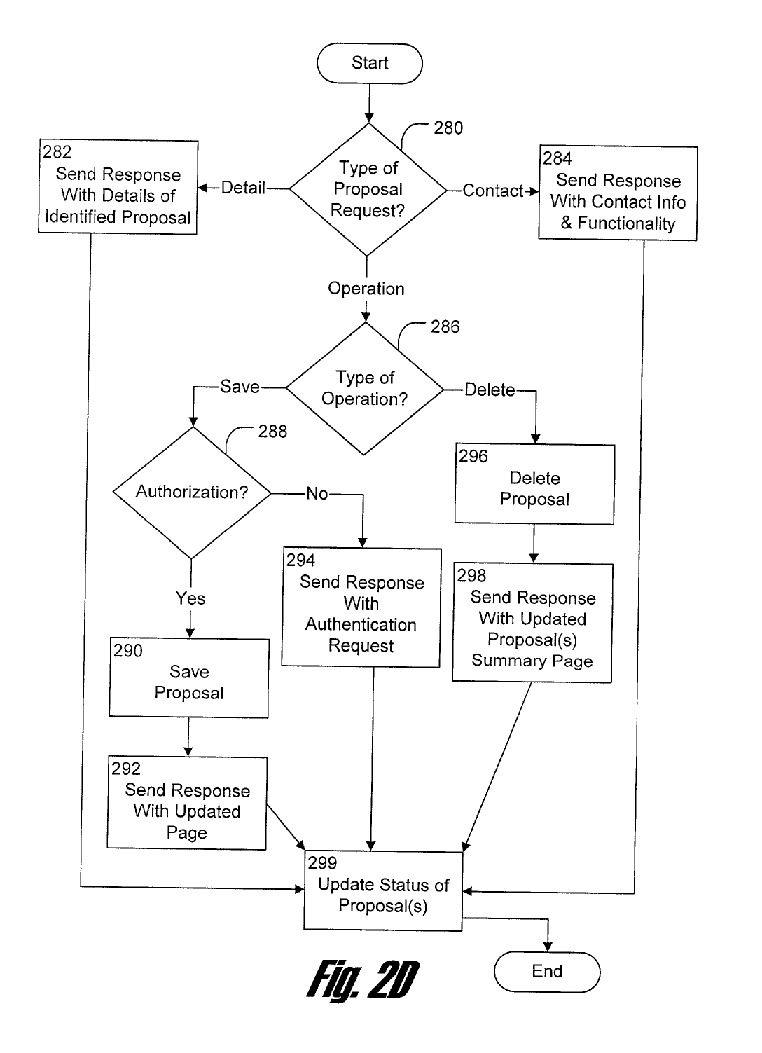

Thus, a registered consumer may have multiple search-requestor access devices 140 associated with her at any given time, each of which includes the user identifier for the registered consumer. But an unregistered consumer will generally have a single search-requestor access device 140 associated with her at any given time (from the perspective of the anonymous lead generating system). Further details concerning how consumers are identified, in one embodiment, is described below in connection with FIGS. 2A and 2B.

Although the server 120 is shown and described in terms of separate databases, multiple organizational structures are available for these databases and the data contained therein, as is well known in the relevant art(s). Additionally, in one embodiment, database software such as Oracle8i, manufactured by Oracle Corporation, located at 500 Oracle Pkwy, Redwood City, Calif. 94065, is used to create and manage these databases.

Additionally, although the invention is disclosed herein in terms of a single centralized server 120 with its own local storage, the present invention encompasses multiple alternative architectures. For example, the functionality described herein can be distributed over a plurality of computers. The various alternative architectures for these types of information systems are well understood in the relevant art(s).

In one embodiment, the server 120 is configured in a distributed architecture, wherein databases and processors within the server 120 are housed in separate units or locations. Some units perform the primary processing functions and contain, at a minimum, memory and a general processor. Each of these units is attached to a wide area network (“WAN”) hub which serves as the primary communications link with the other units and interface devices. The WAN hub may have minimal processing capability itself, serving primarily as a communications router. Those skilled in the relevant art(s) will appreciate that an almost unlimited number of servers may be supported. This arrangement yields a more dynamic and flexible system, less prone to catastrophic hardware failures affecting the entire system.

In an alternative embodiment, the web server 120 is configured in a distributed fashion, such that a separate web server is located in each geographical region. In this embodiment, all the separate web servers taken together form a single web site residing in multiple geographically diverse data centers.

FIGS. 2A and 2B are a combined state diagram and flowchart depicting a process by which activity of a consumer is used to generate prospects enabling creation and delivery of consumer-specific, anonymously-directed proposals according to one embodiment. Referring now to FIG. 2A, an idle state 200 is the default state for an exemplary web site providing the functionality described herein. The idle state 200 is left whenever a request is received. In a defined process step 202, the request is received, a requesting consumer is identified and a determination is made as to the type of request. An example of the defined process step 202 is shown in FIG. 2B and is described in further detail below.

If the defined process step 202 determines that the request is either a request for a search or a request for viewing or processing of search results, the process proceeds to step 204. In step 204, the type of request is assessed. If the request is for a search, the process moves to step 206. If the request is for viewing or processing of search results, the process moves to step 214.

In step 206, the search criteria are stored. In one embodiment, these search criteria are stored in the user database 126 in the user record associated with the user identifier for the requesting consumer. Because multiple searches in different areas may occur, this user record is designed to handle multiple values for the search criteria. In step 208, a prospect for the requesting consumer is created or modified, depending upon whether a prospect is already in existence for this consumer.

Note that in one embodiment, the prospect is the same as the user record, and step 206 and 208 are one in the same. For example the prospect for this consumer (and thus the user record for this consumer) may simply comprise an XML result set.

Following this, the requested search is performed in step 210 using search criteria. In an embodiment in which the business database 128 is part of the server 120, the search is performed directly, and the results of the search are sent to the requesting consumer in a response in step 212. In an embodiment in which the business database 128 is separate from the server 120, the search is performed by passing the search criteria on to the appropriate third party, and step 212 is performed either by the third party or by passing the results of the search, received from the third party, on to the requesting consumer. Following step 212, the process returns to the idle state 200.

In one embodiment, step 208 distinguishes between searches based upon an area of specialty. The area of specialty is a search criteria that affects which business experts can still be considered experts for a searched subset of business areas. For example, in a home-sales embodiment, consumer specified geographic areas of interest represent areas of specialty such that a Realtor® must specialize in one of the specified geographic areas to be eligible to receive an anonymous lead from the prospect generated/modified by the search.

In alternative embodiments, various business rules are used to improve the effectiveness of the present invention. For example, in one embodiment, only active prospects may result in anonymous leads; thus, step 208 also stores the date of the search so that prospects in which no search has been performed in the last seven days become inactive. Likewise, in one embodiment, prospects for unregistered consumers are deleted after sixty days with no activity in the prospect.

In another alternative embodiment, steps 206 and 208 are skipped if the search criteria are directed to specific business items, thereby indicating that the help of a business expert is not needed. For example, in a home-sales embodiment, search criteria that specify one or more MLS numbers indicate that the search requester is either a Realtor® or already working with a Realtor® who gave them that information. Thus, there is no need to create or modify a prospect.

If the request is determined in step 204 to be for viewing or processing of search results generated from a prior search request, the process moves from step 204 to step 214. In step 214, a determination is made as to whether authorization is needed to process the request, but such authorization is not present. For example, in one embodiment, a consumer may save MLS numbers for specific houses found during a search, but in order to do this, the web site requires the consumer to register. If authorization is required and not present, control passes to step 224, in which a response with an authorization request is sent back to the requesting consumer.

In an HTTP embodiment, this response has a 401 Authorization Required status code and a WWW-Authenticate header, which specifies details about how to perform the authentication. If the requesting consumer is already registered, all they need do is respond with their user name and password. This information is received and approved in step 226, and control passes to step 216. If the requesting consumer is not registered, they will be directed to the appropriate registration page. Systems and methods for online registration of users are well known in the relevant art(s).

If the determination is made in step 214 that authorization is not required or authorization is already present (e.g. the request has the appropriate Authorization header included), then control passes to step 216. In step 216, information related to the request is stored. In one embodiment, this information is stored in the user database 126 in the user record associated with the user identifier for the requesting consumer.

This information is any information tending to show the consumer's interest in a particular business item. For example, in one embodiment, whenever a consumer requests a detailed page for one of the homes found in a search or whenever a consumer requests that an MLS number for one of the homes found in a search be saved, this information is stored in step 216. Moreover, in one embodiment, if the information relates to a particular business expert, then the user identifier for this business expert is included in the user record. For example, in a home-sales embodiment, whenever a consumer requests that an MLS number for one of the homes found in a search be saved and the listing agent for this MLS number is a registered Realtor®, then the user identifier for this Realtor® is included in the user record.

In step 218, the prospect for the requesting consumer is modified. Note that in one embodiment, the prospect is the same as the user record, and steps 216 and 218 are one in the same. For example the prospect for this consumer (and thus the user record for this consumer) may simply comprise an XML result set.

Following step 218, the request is processed in step 220 and a response is sent in step 222 with the requested page. If the request was for viewing of the search results, the requested page is the page identified in the request. If the request was for processing of the search results, the page is the same page from which the request was generated with the addition of information indicating the results and/or status of the requested processing. For example, if the request was to save an MLS number, the page sent back in the response is a new page which is the old page modified to show whether the save action was successful.

Following step 222, the process returns to the idle state 200.

FIG. 2B is a flowchart depicting an example of the defined process 202 shown on FIG. 2A. Referring now to FIG. 2B, the process begins with step 230, in which the request is received. Following step 230, the request is checked for a Cookie header in step 232. If a Cookie header is present, control passes to step 238. If not, control passes to step 234.

In step 234, a new user record is created, including a new user identifier. Following this, a Cookie is planted in the requesting device in step 236, before the process moves on to step 240. Note that in one embodiment, step 236 merely ensures that when the next response is sent to the requesting device, this response has a Set-cookie header, which includes the user identifier.

In step 238, the user identifier is retrieved from the Cookie and checked against the user database 126. If the user identifier is invalid, control passes to step 234. If the user identifier is valid, control passes to step 240.

In step 240, the particular type of request is determined. If the request is either a request for a search or a request for viewing or processing of search results, the defined process ends, thereby resulting in the process continuing on to step 204 on FIG. 2A. If the request is for anything else, control passes to step 242. In one embodiment, this request-type determination is made in step 240 using the Universal Resource Locator (“URL”) in the request itself. If the request is for a search, it will include, in addition to the search criteria, a URL that specifies a software tool used to perform searches. If the request is for viewing or processing of search results, the request will include either a URL for a temporary page created to display search results or a URL that specifies a software tool used to perform the requested processing of search results.

In step 242, a status indicator for the identified consumer is checked. This status indicator indicates whether the consumer needs to be notified of new proposals. In one embodiment, this status indicator is stored as part of the user record. In another embodiment, this status indicator is another cookie contained in the Cookie header. For example, in one embodiment, the status indicator may be one of four different cookies: (1) a “View Now” cookie, which is a session cookie that indicates the consumer has selected to view proposals during this session; (2) a “View Later” cookie, which is a session cookie that indicates the consumer has selected not to view proposals during this session; (3) a “Thirty Days” cookie, which is a permanent cookie (with a thirty day expiration) that indicates the consumer has selected to not view any proposals for a month; and (4) a “Never” cookie, which is a permanent cookie (with a ten year expiration) that indicates the consumer has selected to not view any proposals ever.

In an alternative embodiment, step 242 occurs before step 240, and a notification of proposal(s) may be sent to a consumer on a page resulting from a request for search.

Following step 242, a determination is made whether or not to provide a notification of proposals in step 244. If not, control passes to step 248. If so, control passes to step 246. In a cookie status embodiment, step 244 checks whether a status cookie is present and whether the current user is a consumer with proposals. If no status cookie is present and the current user is a consumer with unviewed proposals, this indicates that a notification of proposals needs to be provided.

In step 246, a response is sent to the requesting consumer. This response includes the requested page modified to include a notification of any active proposals. Following step 246, the defined process ends by returning the main process to the idle state 200 on FIG. 2A.

In step 248, the request is processed and a response is sent if appropriate. The particular sub-process used in step 248 depends upon the nature of the request. This is discussed in greater detail below in connection with FIGS. 2C and 2D. Following step 248, the defined process ends by returning the main process to the idle state 200 on FIG. 2A.

FIGS. 2C and 2D are two flowcharts depicting a process by which a consumer is provided access to consumer-specific, anonymously-directed proposals according to one embodiment. FIG. 2C shows an example sub-process from the set of sub-processes 248 on FIG. 2B. This exemplary sub-process shows how a consumer-proposal-view request is handled. Referring now to FIG. 2C, the sub-process starts with step 260, in which the type of proposal view request is assessed. If the proposal view request is to view proposals now, control passes to step 268. If the proposal view request is to cancel the consumer's involvement in the blind proposal system, control passes to step 266. If the proposal view request is to view proposals later, control passes to step 262.

In step 262, the status indicator for the current consumer is set such that the consumer will no longer be notified of the unviewed proposals during this session. In one embodiment, this involves planting a session cookie on the consumer's access device, such as the “View Later” cookie discussed previously.

Following step 262, a response is sent in step 264. This response includes the same page from which the request was generated with the notification of proposals removed. Following this, the sub-process ends, thereby returning the main process to the idle state 200 on FIG. 2A.

In step 266, the status indicator for the current consumer is set such that the consumer will no longer be notified of the unviewed proposals. Once this status indicator is set, no notifications of proposals are presented to this consumer again, until the consumer changes this setting. In addition, in one embodiment, the prospect for this consumer immediately becomes inactive, thereby preventing wasted time on the part of business experts.

In one embodiment, the setting of the status indicator involves planting a permanent cookie on the consumer's access device, such as the “Thirty Days” cookie or the “Never” cookie discussed previously.

Following step 266, a response is sent in step 264, before the sub-process ends, thereby returning the main process to the idle state 200 on FIG. 2A.

In step 268, the status indicator for the current consumer is set such that the consumer will no longer be notified of unviewed proposals during this session. In one embodiment, this involves planting a session cookie on the consumer's access device, such as the “View Now” cookie discussed previously.

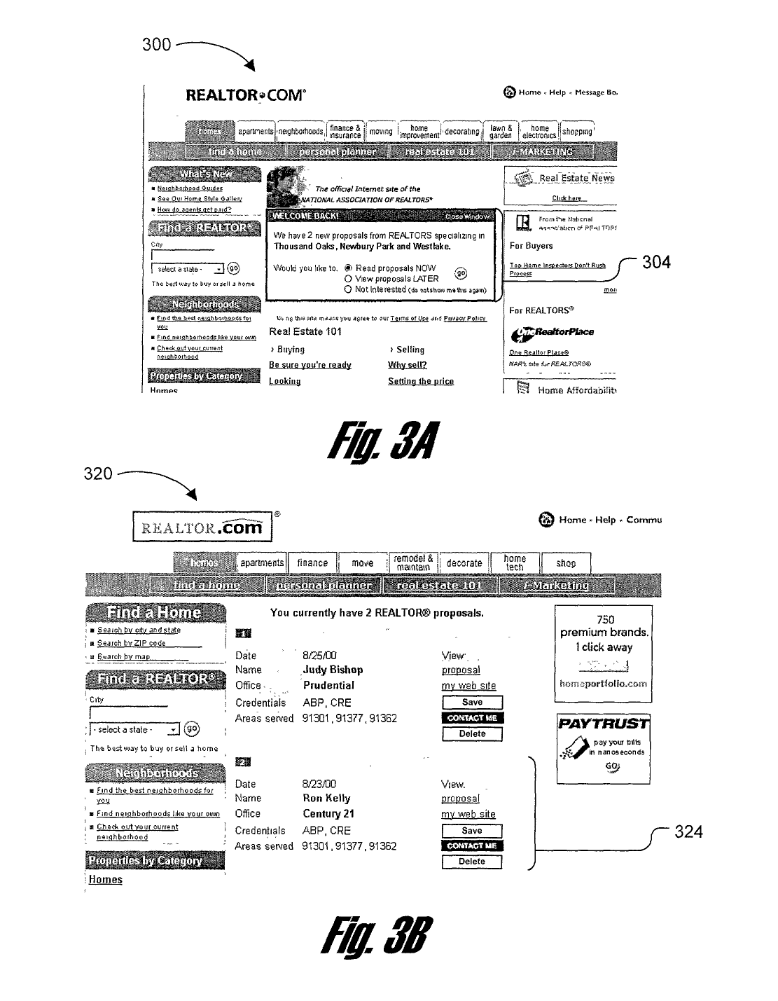

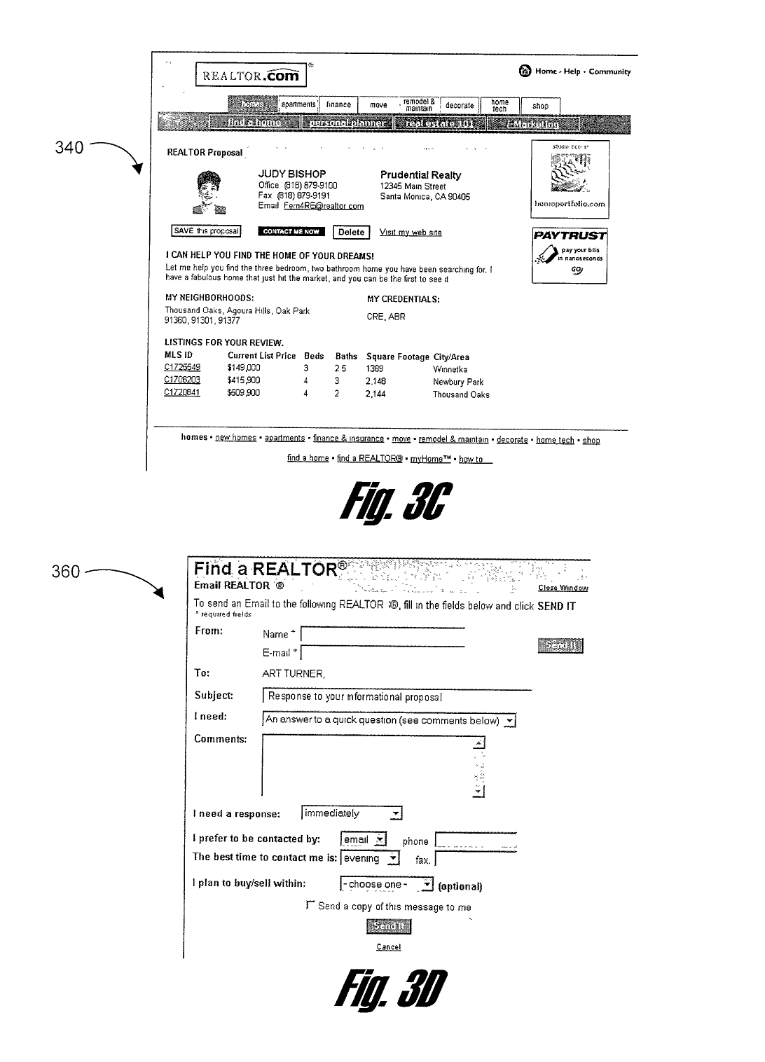

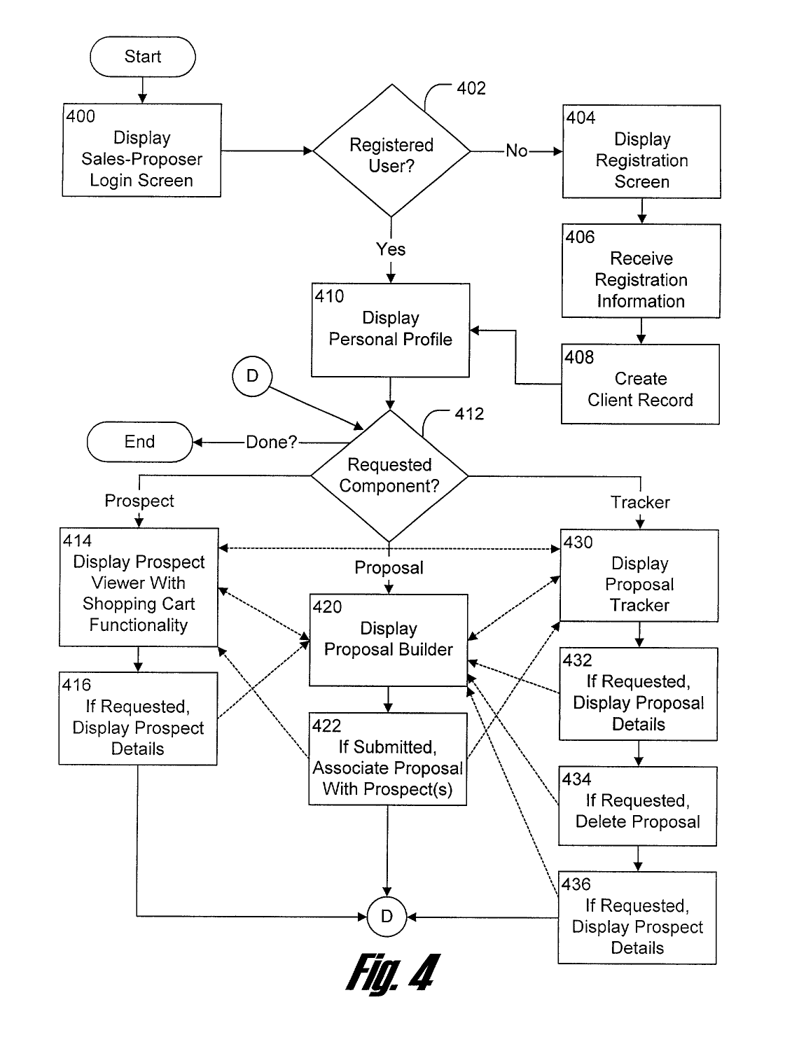

Then, in step 270, a response is sent back to the consumer. This response includes a proposal summary page, which lists the key information connected with each proposal. For example, in one embodiment, the proposal summary page includes a date for each proposal, a name for the business expert, a company affiliation, a listing of any credentials and a listing of the business areas of specialty. An example of such a proposal summary page is shown and described below in connection with FIG. 3B. Following step 270, the sub-process ends, thereby returning the main process to the idle state 200 on FIG. 2A.

In addition, in one embodiment, the proposals themselves are monetized. For example, a business expert may be allowed to pay a fee so that her proposals will show up at the top of the list when the proposals are presented to the consumer.

FIG. 2D shows an example sub-process from the set of sub-processes 248 on FIG. 2B. This exemplary sub-process shows how a consumer-proposal request is handled. Thus, if a consumer selected the “view now” option in step 260 on FIG. 2C, the response sent back in step 266 includes a page presenting options, which if selected cause this example sub-process to be performed. Referring now to FIG. 2D, the sub-process starts with step 280, in which the type of consumer-proposal request is assessed. If the consumer-proposal request is to contact a business expert, control passes to step 284. If the consumer-proposal request is to perform some operation, control passes to step 286. If the consumer-proposal request is to view details of a proposal, control passes to step 282.

In step 282, a response is sent to the consumer. The response includes a page that contains the details of the identified proposal. An example of such a proposal details page is shown and described in connection with FIG. 3C below. Following step 282, the proposal statuses are updated in step 299, before the sub-process ends, thereby returning the main process to the idle state 200 on FIG. 2A.

In step 284, a response is sent to the consumer. The response includes contact information, and preferably the response also includes functionality to implement the contact. For example, in one embodiment, the response is a page with an email reply screen. This allows the consumer to create and send an email to the particular business expert. Additionally, in one embodiment, the contact functionality enables anonymous communication between the consumer and the business expert. This anonymous communication functionality may be implemented using email, with chat sessions, etc. Alternative embodiments include use of a toll-free telephone number and instant messenger services. Preferably, any contact information and related functionality provided in the response includes a mechanism for tracking and recording the contact.

In addition, in one embodiment, an initiation of contact by a consumer also affects the prospect for that consumer. For example, opening a chat session with a particular business expert may temporarily make the prospect for the initiating consumer inactive (since the consumer has expressed an interest in using that particular business expert), thereby giving the particular business expert a window of opportunity with the particular consumer. In general, any indication that a consumer has an interest or preference for a particular business expert may be used to temporarily or semi-permanently suppress that consumer from the lead generation system (either entirely, or such that leads are generated only for the particular business expert).

For example, in the email embodiment, the email is sent to the business expert through the web site, thereby enabling tracking and recording of this contact. Moreover, if only contact information is provided, this contact information preferably routes the contact through a mechanism for tracking and recording the contact, such as a toll-free telephone number service with voice recognition or touch tone phone menu options provided. Those skilled in the art will understand how to implement these various embodiments given the disclosure provided herein.

Following step 284, the proposal status is updated in step 299, before the sub-process ends, thereby returning the main process to the idle state 200 on FIG. 2A.

In step 286, the type of requested operation is assessed. If the operation is a save operation, control passes to step 288. If the operation is a delete operation, control passes to step 296. In step 296, the identified proposal is deleted. Following this, a response is sent to the consumer in step 298. The response includes the same proposal summary page, only updated to reflect the proposal deletion. Following this, a proposal tracking record is updated in step 299 thereby enabling tracking of the proposal for the business expert, before the sub-process ends, thereby returning the main process to the idle state 200 on FIG. 2A. Note that in one embodiment, the proposal serves as its own tracking record, thus step 296 updates the proposal, and step 299 is not needed.

If the operation is determined to be a save operation in step 286, the request is checked for an Authorization header in step 288. If an Authorization header is present, the user name and password are obtained from the Authorization header, the user database 126 is searched for this user name, and the password is checked. If the user name is found and the password matches, control passes to step 290. If the user name is not found in the user database 126, or if the password does not match that stored for the particular consumer, control passes to step 294.

In step 294, a response with an authorization request is sent back to the requesting consumer. In an HTTP embodiment, this response has a 401 Authorization Required status code and a WWW-Authenticate header, which specifies details about how to perform the authentication. If the requesting consumer is already registered, all they need do is respond with their user name and password. If the requesting consumer is not registered, they will be directed to the appropriate registration page. Following step 294, the proposal status is updated in step 299, before the sub-process ends, thereby returning the main process to the idle state 200 on FIG. 2A. Alternatively, if the requesting consumer logs in or registers successfully, the process proceeds to step 290.

If authorization was obtained in step 288, the process moves from step 288 to step 290, in which the proposal, or portions thereof, are saved. In one embodiment, the proposal is saved in step 290 by setting a saved-flag in the proposal record. Following step 290, a response is sent to the consumer in step 292. The response includes the same proposal summary page, only updated to reflect that the selected proposal has been saved (or not saved, if some failure occurred). Following this, the proposal status is updated in step 299, before the sub-process ends, thereby returning the main process to the idle state 200 on FIG. 2A.

FIGS. 3A, 3B, 3C and 3D are illustrations showing exemplary web pages for implementing various steps in the process by which a consumer is provided access to consumer-specific, anonymously-directed proposals according to one embodiment. Referring now to FIG. 3A, an example home page 300 is shown. This example home page 300 has been modified to include a notification of proposals 304, as discussed previously in connection with step 244 on FIG. 2B. Although this modification is shown here in connection with a home page, the notification of proposals 304 may be added to all requested web pages, or all requested web pages that are neither search pages nor pages generated from search operations. In one embodiment, however, the notification of proposals 304 is added only to the home page.

The notification of proposals 304 includes three options, “read proposals now”, “view proposals later” and “not interested.” These three options were discussed previously in connection with FIG. 2C. If the consumer selects the “read proposals now” option, the server 120 transmits a proposal viewing page such as that shown in FIG. 3B.

Referring now to FIG. 3B, an example proposal viewing page 320 is illustrated. This proposal viewing page 320 is an example of the proposal summary page referred to in step 266 on FIG. 2C. An example proposal summary 324 is shown. The example proposal summary 324 includes the key information connected with each proposal, such as date, business expert name, company affiliation, credentials and areas of specialty information. Also included on the example proposal summary 324 are control inputs for affecting the view-proposal-details, contact, save and delete functionality. If the consumer selects the view-proposal control-input, the server 120 transmits a proposal details page such as that shown in FIG. 3C. If the consumer selects the contact control-input, the server 120 transmits an email page such as that shown in FIG. 3D.

Referring now to FIG. 3C, an example proposal details page 340 is illustrated. The proposal details page 340 includes all the information connected with the selected proposal. In addition, in one embodiment, the proposal details page 340 also includes the same functionality, such as contact, save and delete options, as used on the proposal viewing page 320.

Referring now to FIG. 3D, an example email reply screen 360 is illustrated. This email reply screen 360 enables the consumer to contact the business expert. The email generated from this email reply screen 360 is sent to the business expert via the web site, thereby enabling tracking and recording of the contact. In addition, in one embodiment, all contacts between the consumer and the business expert are conducted through emails going through the web site, which aliases the consumer's email address. Thus, the business expert and the consumer may have active and ongoing communications without the business expert learning contact information for the consumer. In this fashion the consumer can maintain her anonymity as long as desired, while still obtaining the benefits of advice from an expert in the area.

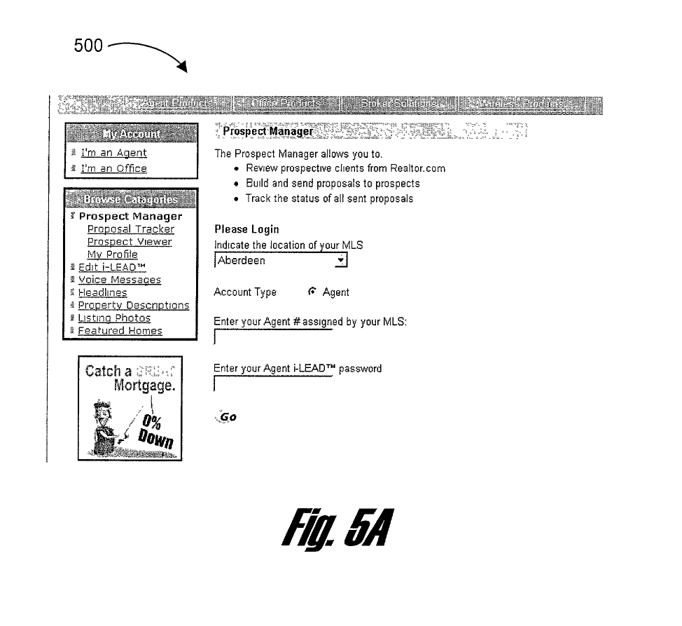

FIG. 4 is a flowchart depicting a process by which creation and delivery of consumer-specific, anonymously-directed proposals is enabled according to one embodiment. As such, FIG. 4 represents the functionality of a prospect manager for a business expert, according to one embodiment. Referring now to FIG. 4, the process begins with step 400, in which a business expert login screen is displayed to a business expert in response to a request. The business expert enters user name and password information, which is then submitted to the server 120.

In step 402, the user database 126 is checked for the submitted user name and password. If the business expert is a registered user, control passes to step 410. If not, control passes to step 404. In step 404, a response is sent, which causes a registration screen to be displayed. If the business expert submits registration information, it is received in step 406. After step 406, a user record is created and saved in the user database 126, in step 408. Following this, the process moves on to step 410.

In one embodiment, this registration information comprises a complete profile of the business expert, including personal and business information. In an alternative embodiment, online registration is not allowed.

In step 410, the personal profile for the business expert is displayed. This profile screen allows the business expert to change her personal profile information. In one real-estate embodiment, the profile information includes the MLS number(s) the business expert is associated with and the primary neighborhoods or city names in which they do business (input via an area selector portion of the profile screen). In addition, in one embodiment, the profile screen allows the business expert to identify her primary neighborhoods or city names by clicking on an interactive map. In one embodiment, additional data for use by the other parts of the prospect manager are also downloaded in step 410, thereby reducing the perception of delay which could be caused by a large number of prospects for a business expert.

All screens in the prospect manager provide access to the main parts of the prospect manager, including a prospect viewer, a proposal builder, a proposal tracker, and the profile screen. Thus, the business expert can easily navigate between the various components of the prospect manager. In addition, the prospect manager provides access to various other sub-components that enable personalization of the prospect-proposal system, such as a sub-component that allows the business expert to change her method of notification (e.g. email, voice mail, etc.).

In one embodiment, the prospect manager provides access to the various components and sub-components via a side-bar navigation option. Thus, the business expert can reach any component from any other component quickly and easily.

In step 412, a request is received from the business expert. If the request is for something other than a component of the prospect manager, the process ends. If the request is for the prospect viewer, this is determined in step 412, and the process moves to step 414. In step 414, a response is sent to the business expert. This response causes the prospect viewer to be displayed to the business expert. The prospect viewer lists prospect information from all active prospects in the specialty areas served by the business expert. Preferably, this prospect viewer has “shopping cart” functionality built into it (e.g. a “power prospector”), thereby enabling the business expert to select a set of prospects to which the same proposal can be sent.

In one embodiment, the prospect viewer also distinguishes between normal prospects and “hot prospects.” For example, in one embodiment, prospects that come from consumers who have specifically requested proposals, such as by registering with the web site and filling out a request/profile form, are presented as “hot prospects.” Additionally, in a home-sales embodiment, prospects that come from consumers who have saved a home listed by a particular Realtor® are presented as “hot prospects” to that particular Realtor®. The term “hot prospect” means that these prospects are distinguished from other prospects in some fashion. The distinction between prospects can be done in any number of manners, such as by the order of the listing or by presenting hot prospects in red.

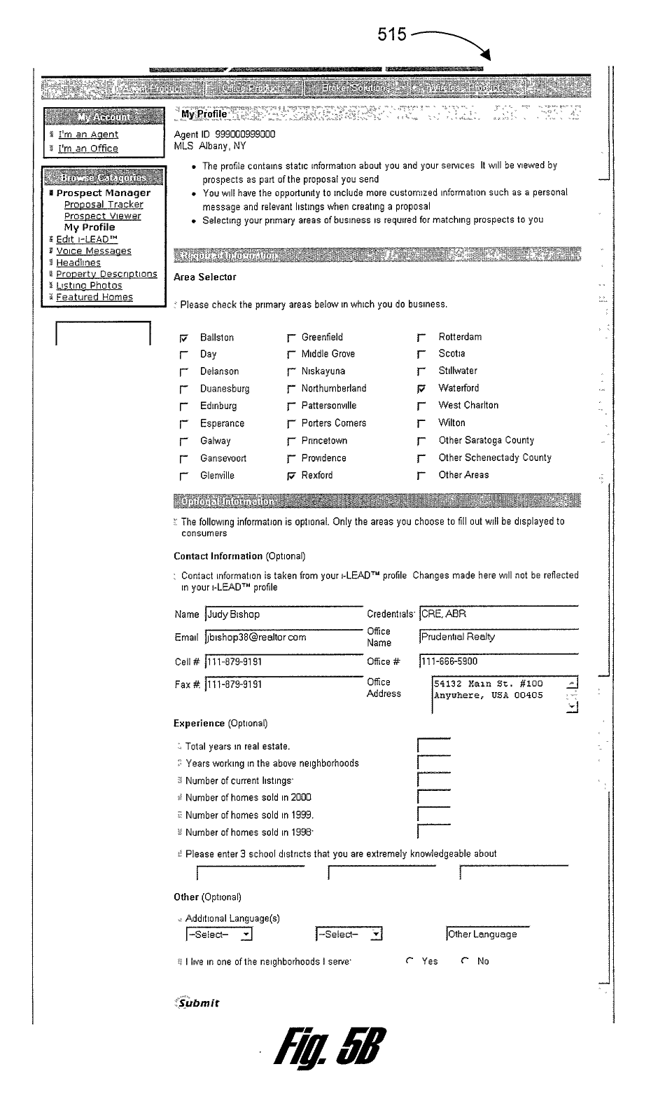

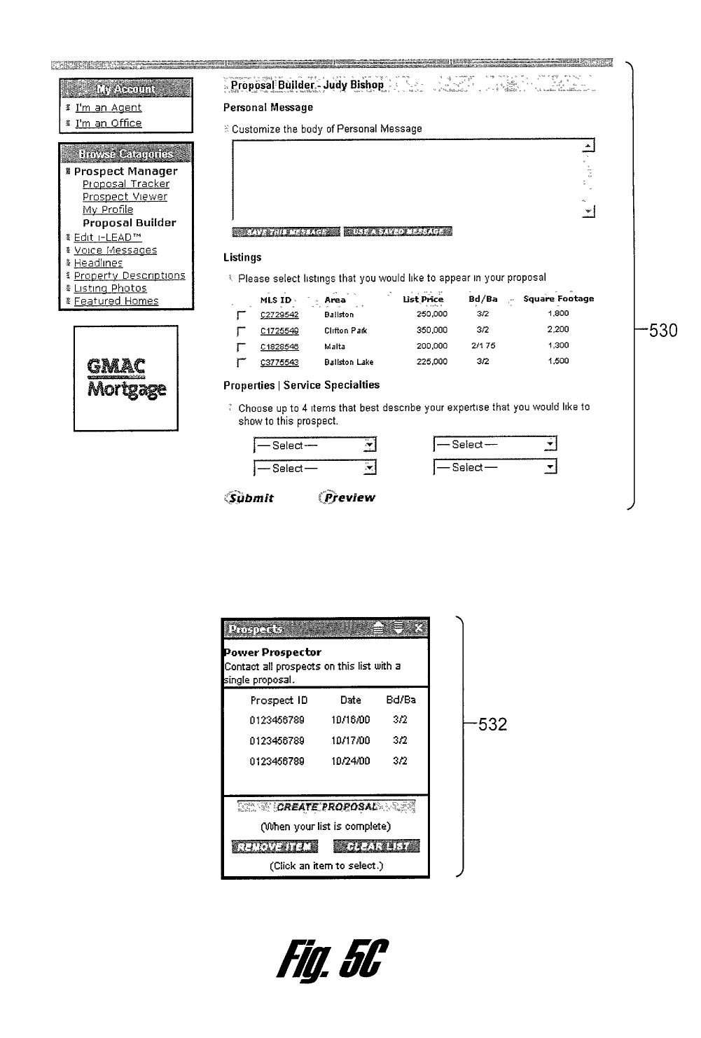

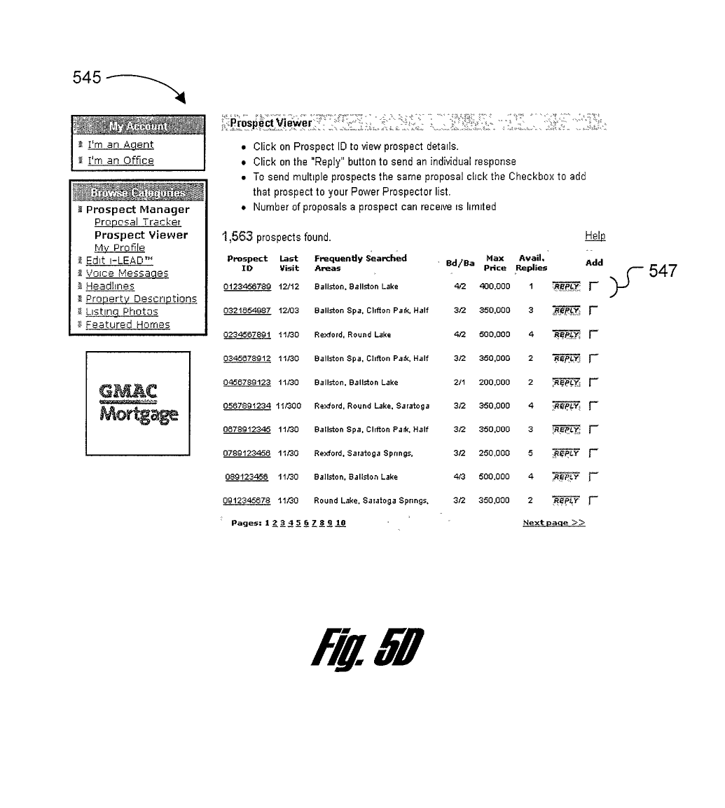

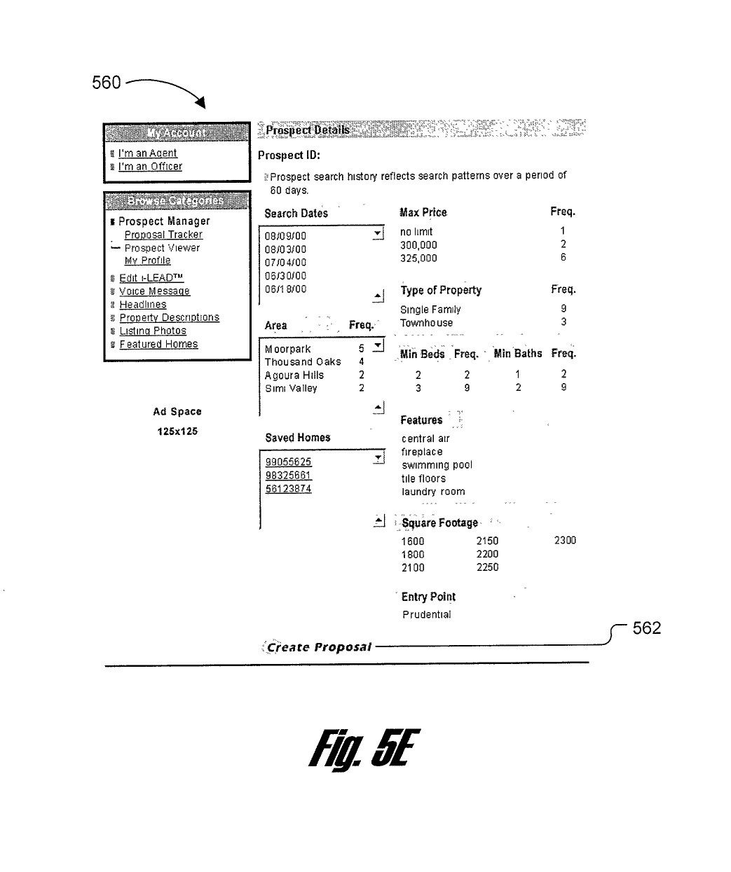

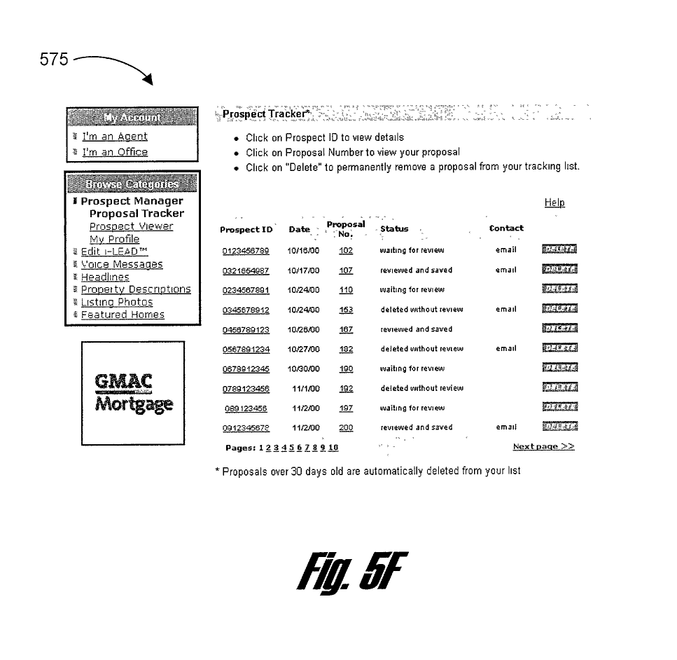

In addition, in one embodiment, the prospect viewer enables the business expert to conduct prospect searching to select prospects by search criteria or to organize prospects by category (i.e. clicking on the column headers for the prospects causes the prospect viewer to resort the prospects by the values under that column header). Examples of such column headers are shown in FIG. 5D.

Prospects presented in the prospect viewer are made available on a first-come, first-serve basis. Only a limited number of proposals are allowed for each prospect. This is done to prevent a consumer from being bombarded with numerous proposals, which could undermine the intention of simplifying the consumer's work in finding a home. In one embodiment, only five proposals are allowed for each prospect. Moreover, when prospects become too old, they are deleted. For example, in one embodiment, prospects that are more than sixty days old are deleted.

Various other business rules may be used to improve the effectiveness of the present invention. For example, in one embodiment, (1) a Realtor® cannot send a proposal to the same prospect more than once, (2) hot prospects are reserved for three days and presented as an active prospect only to the Realtor® owning the saved listing during those three days (after three days, the prospect may show up as a regular prospect to all Realtors® in that area), (3) a maximum of 10 prospects may be added to the shopping cart at any one time, and (4) once a consumer has selected a Realtor®, that consumer's user identifier is associated with the Realtor® such that the prospect for that consumer will not be presented to any other Realtor®.

In addition, in one embodiment, the method by which the consumer originally came to the anonymous lead generating system is recorded and affects whether that consumer's prospect is presented to a particular business expert in the prospect viewer. For example, in a web site embodiment, a consumer may come to the web site through any number of gateways. If the consumer does come to the web site through an associated gateway, that associated gateway is saved as part of the prospect. The prospect for this consumer is then only presented to business experts who are affiliated with this associated gateway. If the consumer comes in on an associated gateway either before or after coming in on a general gateway or no gateway at all, the general gateway overrides the associated gateway; thus the prospect for this consumer may be presented to all business experts regardless of affiliation.

If requested, a prospect details screen is displayed to the business expert in step 416. Then, the process returns to step 412. If a request is received for the proposal builder, this is determined in step 412, and the process moves to step 420. In step 420, a response is sent to the business expert. This response causes the proposal builder to be displayed to the business expert. The proposal builder gives business experts a simple interface through which they may quickly compose a proposal to a selected prospect or group of prospects. In one embodiment, the business expert can select from a pre-defined menu of subject lines and response paragraphs, create, save and re-use customized messages, and choose MLS numbers from home listings to include in the proposal for consumer review.

The proposal builder saves the proposal such that it is associated with the prospect(s) and with the user record for the business expert in step 422. Additional information may be included in the proposal, such as professional experience, links to school reports, neighborhood information, etc. Moreover, this additional information may also be incorporated into pre-defined menus.

If a request is received for the proposal tracker, this is determined in step 412, and the process moves to step 430. In step 430, a response is sent to the business expert. This response causes the proposal tracker to be displayed to the business expert. If a request for proposal details is received, a proposal details screen is displayed in step 432. If a request to delete a proposal is received, the proposal is deleted in step 434. If a request to display prospect details is received, a prospect details screen is displayed in step 436. In addition, in one embodiment, the proposal tracker also includes “shopping cart” functionality for all these steps, and the proposal tracker alerts the business expert whenever a prospect, on which an existing proposal is based, has changed.

As will be understood by those skilled in the art, the process shown in FIG. 4 allows a business expert to navigate between any of the components of the prospect manager. This functionality is shown graphically with dashed arrow lines on FIG. 4.

FIGS. 5A, 5B, 5C, 5D, 5E and 5F are illustrations showing exemplary web pages for implementing various steps in the process by which creation and delivery of consumer-specific, anonymously-directed proposals is enabled according to one embodiment. Referring now to FIG. 5A, an example login page 500 is shown. The login page 500 allows a Realtor® to login or register from the same page. If the Realtor® is registering, or if the Realtor® decides to change their areas of specialty, they are presented with an area selector, which may be menu based or map based. Referring now to FIG. 5B, an example business expert profile page 515 is shown. The area selector portion of the profile page 515 allows a Realtor® to select her particular areas of specialty.

Referring now to FIG. 5C, an example proposal builder 530 and power prospector 532 are shown. The proposal builder 530 gives a Realtor® a web-interface through which she may quickly compose a proposal for a prospect or a group of prospects. The power prospector 532 is one approach to enabling submission of a common proposal to many prospects. Another is to use shopping cart functionality built into the prospect viewer.

Referring now to FIG. 5D, an example prospect viewer 545 is shown. The prospect viewer shows prospect information for all the prospects for this Realtor®. A prospect information set 547 is an example of the type of prospect information displayed and includes prospect ID, search date, areas, property type, bedroom/bathroom, price range, MLS numbers saved and Realtor® replies information. The prospect ID uniquely identifies the prospect but does not reveal contact information for the consumer behind the prospect. Each prospect is presented so that the Realtor® cannot contact the consumer without using the proposal builder components.

Referring now to FIG. 5E, an example prospect detail page 560 is shown. This prospect detail page 560 includes all the relevant information for the prospect. Once again, no information is presented that would allow the Realtor® to contact the consumer without using the proposal builder components. If a create proposal button 562 is selected, this causes a proposal builder page to be presented.

Referring now to FIG. 5F, an example proposal tracker page 575 is shown. The functionality described previously is implemented in this example proposal tracker page 575 using HTML/XML forms, etc. Those skilled in the art will understand how to build this example proposal tracker page 575 and how this example proposal tracker page 575 functions given the disclosure herein.

While various embodiments of the present invention have been described above, it should be understood that they have been presented by way of example only, and not limitation. It is to be understood that the description and drawings represent the presently preferred embodiment of the invention and are, as such, representative of the subject matter which is broadly contemplated by the present invention.

Furthermore, the scope of the present invention fully encompasses other embodiments that may become obvious to those skilled in the relevant art(s). For example, the present invention could be applied equally well in the context of automobile or airplane ticket sales. Thus, the breadth and scope of the present invention should not be limited by any of the above-described exemplary embodiments, but should be defined only in accordance with the following claims and their equivalents.

What is claimed is:

1. A computer-implemented method for generating anonymous leads from anonymously submitted database search criteria, comprising:
(a) generating a prospect having:
(i) device-identifying information,
(ii) prospect-identifying information, and
(iii) search information corresponding to anonymously submitted search criteria;
(b) providing prospect information to a business expert in a prospect presentation, wherein the prospect presentation is designed to enable generation of a proposal, and wherein the prospect information does not include the device-identifying information from the prospect; and
(c) providing proposals to devices associated with prospects for which the proposals are generated.

2. The computer-implemented method of claim 1, wherein the search information also corresponds to post-search browsing activity data.

3. The computer-implemented method of claim 1, wherein the prospect information relates to a plurality of prospects, all of which are active.

4. The computer-implemented method of claim 1, further comprising:
(a) notifying a business expert of a new prospect; and
(b) tracking a status of a proposal.

5. The computer-implemented method of claim 1, wherein the prospect also has gateway information if available, and wherein the prospect information provided to a specific business expert does not include data from prospects having particular gateway information if the specific business expert does not have an affiliation with the particular gateway.

6. The computer-implemented method of claim 1, wherein the providing proposals step comprises:
(a) receiving a request for a formatted set of data, wherein the request includes a device identifier;
(b) checking a status indicator to determine whether a proposal should be provided;
(c) adding a proposal notification to the requested formatted set of data, if the checking step results in a determination that a proposal should be provided; and
(d) sending the formatted set of data.

7. The computer-implemented method of claim 6, wherein the proposal notification provides a link to a proposal-viewer, which enables anonymous communication between the device user and the business expert.

8. The computer-implemented method of claim 7, wherein the status indicator is included in the request, and wherein the formatted set of data comprises a web page, the prospect presentation comprises one or more web pages, the proposal-viewer comprises one or more web pages, the device identifier comprises a cookie, the status indicator comprises a cookie, and the prospect comprises an XML data set.

9. A computer system for anonymously connecting business experts with consumers, comprising:
(a) a database for storing prospects having search information corresponding to anonymously submitted search criteria; and
(b) a server engine coupled with a network and the database, the server engine being configured to:
(i) receive requests including device-identifying information and anonymously submitted search criteria;
(ii) generate the prospects;
(iii) supply a business database with the anonymously submitted search criteria;
(iv) provide anonymous leads derived from the prospects; and
(v) furnish proposals directed to users of identified devices.

10. The computer system of claim 9, further comprising the business database.

11. The computer system of claim 9, wherein the search information also corresponds to post-search browsing activity data.

12. The computer system of claim 9, wherein the server engine is further configured to not provide anonymous leads derived from particular prospects to particular business experts based upon gateway information for the particular prospects and gateway affiliation information for the particular business experts.

13. The computer system of claim 9, wherein the server engine is configured to furnish the proposals by selective use of session identifiers and device identifiers.

14. The computer system of claim 13, wherein the server engine is further configured to enable anonymous communication between proposal generators and proposal receivers.

15. The computer system of claim 13, wherein the business database contains data regarding real estate, and wherein the server engine comprises a web server, the session identifiers are session cookies, and the device identifiers are permanent cookies.

16. A computer readable medium having computer program instructions stored therein, the computer program instructions comprising instructions for:
(a) generating a prospect having:
(i) device-identifying information,
(ii) prospect-identifying information, and
(iii) search information corresponding to anonymously submitted search criteria;
(b) providing prospect information to a business expert in a prospect presentation, wherein the prospect presentation is designed to enable generation of a proposal, and wherein the prospect information does not include the device-identifying information from the prospect; and
(c) providing proposals to devices associated with prospects for which the proposals are generated.

17. The computer readable medium of claim 16, wherein the search information also corresponds to post-search browsing activity data.

18. The computer readable medium of claim 16, wherein the prospect also has gateway information if available, the computer program instructions further comprising instructions for:
(a) checking for gateway information prior to executing the providing prospect information instructions; and
(b) excluding specific business experts from receiving prospect information associated with a gateway if the specific business experts lack an association with the gateway.

19. The computer readable medium of claim 16, further comprising instructions for:
(a) receiving a request for a formatted set of data, wherein the request includes a device identifier;
(b) checking a status indicator to determine whether a proposal should be provided;
(c) adding a proposal notification to the requested formatted set of data, if the checking step results in a determination that a proposal should be provided; and
(d) sending the formatted set of data.

20. The computer readable medium of claim 19, wherein the status indicator is included in the request, and wherein the formatted set of data comprises a web page, the prospect presentation comprises one or more web pages, the proposal-viewer comprises one or more web pages, the device identifier comprises a cookie, the status indicator comprises a cookie, and the prospect comprises an XML result set.

21. A computer-implemented method for anonymously connecting sales agents with consumers of housing, comprising:
(a) providing a software application designed to communicate with a database containing information regarding housing, wherein the software application is accessible via a computer network and enables searching of the database, whereby search criteria is stored in association with search-requestor information without a requirement of user registration; and
(b) wherein the software application generates prospects from the search criteria for viewing, and the software application enables generation of search-requestor-directed proposals based upon the prospects without revealing contact information for the search-requestor.

22. The computer-implemented method of claim 21, wherein the software application further enables anonymous communication between a proposal-creator and a proposal-receiver.

23. The computer-implemented method of claim 21, wherein the information regarding housing includes information regarding real estate for sale, information regarding factory-built homes, information regarding common interest developments, and information regarding apartments for rent.

24. The computer-implemented method of claim 21, wherein the software application comprises:
(a) a presentation layer;
(b) a middle layer, having business rule implementation objects, communications objects and database messaging objects; and
(c) a database.

25. The computer-implemented method of claim 24, wherein the database messaging objects include objects for translating XML data into a database-specific format.
